(19) United States
(12) Patent Application Publication
(10) Pub. No.: US 2024/0305756 A1
(43) Pub. Date: Sep. 12, 2024

(54) PROJECTOR, METHOD FOR CONTROLLING PROJECTOR, AND NON-TRANSITORY COMPUTER-READABLE STORAGE MEDIUM STORING PROGRAM

(71) Applicant: SEIKO EPSON CORPORATION, Tokyo (JP)

(72) Inventor: Masataka MIYAMOTO, MATSUMOTO-SHI (JP)

(21) Appl. No.: 18/599,480

(22) Filed: Mar. 8, 2024

(30) Foreign Application Priority Data
Mar. 8, 2023 (JP) 2023-035335

(51) Int. Cl. H04N 9/31

(52) U.S. Cl. CPC H04N 9/3185; H04N 9/3188; H04N 9/3194

(57) ABSTRACT

A projector includes an optical device and a processing device, the processing device executes projecting image light of a projection image having a first length and including a first image whose length relationship with the first length is known onto a projection surface by using the optical device, receiving an input of a second length that is a length of the first image on the projection surface, and outputting information indicating a third length that is a length of the projection image on the projection surface based on the second length and the length relationship.

The present application is based on, and claims priority from JP Application Serial Number 2023-035335, filed Mar. 8, 2023, the disclosure of which is hereby incorporated by reference herein in its entirety.

### BACKGROUND

### 1. Technical Field

The present disclosure relates to a projector, a method for controlling the projector, and a non-transitory computer-readable storage medium storing a program.

### 2. Related Art

A projector that calculates a projection image size is known. A projector disclosed in JP-A-2015-163930 includes a distance-measuring sensor that measures a distance from the projector to a screen. The projector measures the distance from the projector to the screen by using the distance-measuring sensor. The projector calculates the projection image size based on the measured distance from the projector to the screen.

JP-A-2015-163930 is an example of the related art.

The projector disclosed in JP-A-2015-163930 includes the distance-measuring sensor in order to calculate the projection image size. Since the distance-measuring sensor is provided, a manufacturing cost of the projector is increased.

### SUMMARY

A projector of the present disclosure includes: an optical device; and a processing device, in which the processing device executes projecting image light of a projection image having a first length and including a first image whose length relationship with the first length is known onto a projection surface by using the optical device, receiving an input of a second length that is a length of the first image on the projection surface, and outputting information indicating a third length that is a length of the projection image on the projection surface based on the second length and the length relationship.

A method for controlling a projector of the present disclosure includes: projecting image light of a projection image having a first length and including a first image whose length relationship with the first length is known onto a projection surface from a projector; receiving an input of a second length that is a length of the first image on the projection surface; and outputting information indicating a third length that is a length of the projection image on the projection surface based on the second length and the length relationship.

A program of the present disclosure causes a projector to execute: projecting image light of a projection image having a first length and including a first image whose length relationship with the first length is known onto a projection surface; receiving an input of a second length that is a length of the first image on the projection surface; and outputting information indicating a third length that is a length of the projection image on the projection surface based on the second length and the length relationship.

### BRIEF DESCRIPTION OF THE DRAWINGS

FIG. 1 is a diagram showing a schematic configuration of a projection system.

FIG. 2 is a diagram showing a schematic configuration of a projection image projected onto a projection surface.

FIG. 3 is a diagram showing a schematic configuration of a projector.

FIG. 4 is a diagram showing a block configuration of the projector.

FIG. 5 is a diagram showing an example of the projection image including an OSD image.

FIG. 6 is a diagram showing an example of the projection image including an OSD image.

FIG. 7 is a diagram showing an example of the projection image including an OSD image.

FIG. 8 is a diagram showing an example of the projection image including an OSD image.

FIG. 9 is a diagram showing an example of the projection image including an OSD image.

FIG. 10 is a diagram showing an example of the projection image including an OSD image.

FIG. 11 is a diagram showing an example of the projection image including an OSD image.

FIG. 12 is a diagram showing an example of the projection image including an OSD image.

FIG. 13 is a diagram showing an example of the projection image including an OSD image.

FIG. 14 is a diagram showing an example of the projection image including an OSD image.

FIG. 15 is a flowchart showing a control flow executed by the projector and a user.

### DESCRIPTION OF EMBODIMENTS

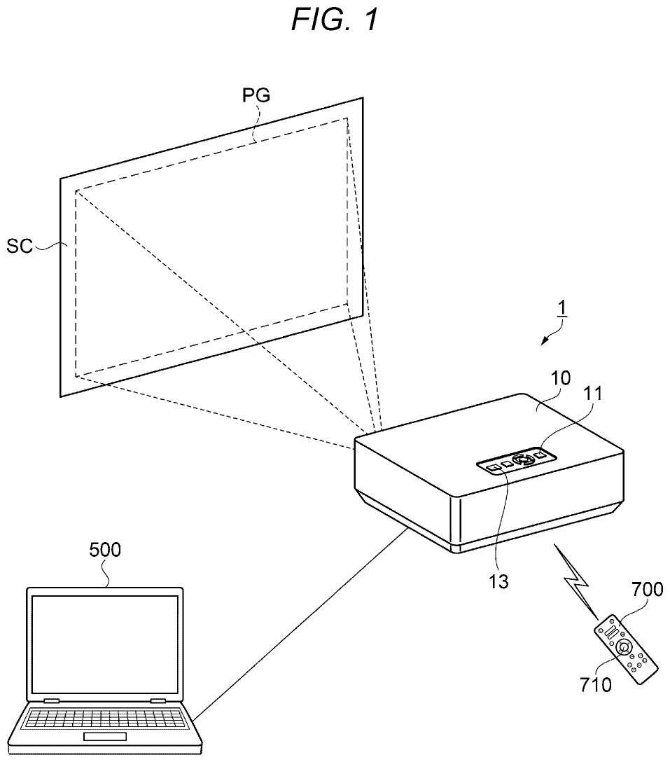

FIG. 1 shows a schematic configuration of a projection system 1. The projection system 1 includes a projector 10 and an image-providing device 500. The projector 10 projects a projection image PG onto a projection surface SC. The projection system 1 shown in FIG. 1 includes one image-providing device 500, but is not limited thereto. A plurality of image-providing devices 500 may be coupled to the projector 10.

The projection surface SC displays the projection image PG projected from the projector 10. The projection surface SC shown in FIG. 1 is implemented by a screen, but is not limited thereto. The projection surface SC may be an indoor wall, a ceiling, an outer wall of a building, or the like. A projection surface shape of the projection surface SC is not limited to a flat surface, and may be a three-dimensional shape such as a curved surface, a surface having unevenness, or a spherical surface.

The projector 10 is disposed at a position where the projector 10 faces the projection surface SC. The projector 10 is communicably connected to the image-providing device 500. The projector 10 may be communicably connected to a control device different from the image-providing device 500. The projector 10 receives image data from the image-providing device 500. The projector 10 projects the projection image PG onto the projection surface SC based on the image data. The projector 10 may project the projection image PG onto the projection surface SC based on display data stored therein.

The projector 10 includes an operation panel 11. The operation panel 11 is operated by a user. The user performs various settings of the projector 10 by performing an input operation on the operation panel 11. The operation panel 11 includes a plurality of input buttons 13. The operation panel 11 corresponds to an example of an input device.

The image-providing device 500 is communicably connected to the projector 10. The image-providing device 500 transmits the image data to the projector 10. The image-providing device 500 may have a function of adjusting an image shape of the projection image PG projected onto the projection surface SC by the projector 10. The image-providing device 500 is a tablet terminal, a smartphone, a mobile computer, a desktop computer, or the like.

The projection system 1 may include a remote controller 700. The remote controller 700 has an infrared communication function or a Bluetooth communication function. The Bluetooth is a registered trademark. The remote controller 700 communicates with the projector 10. The remote controller 700 includes a plurality of operation buttons 710. When the user operates the operation buttons 710, the remote controller 700 transmits an operation signal to the projector 10. The projector 10 receives the operation signal and operates based on the operation signal.

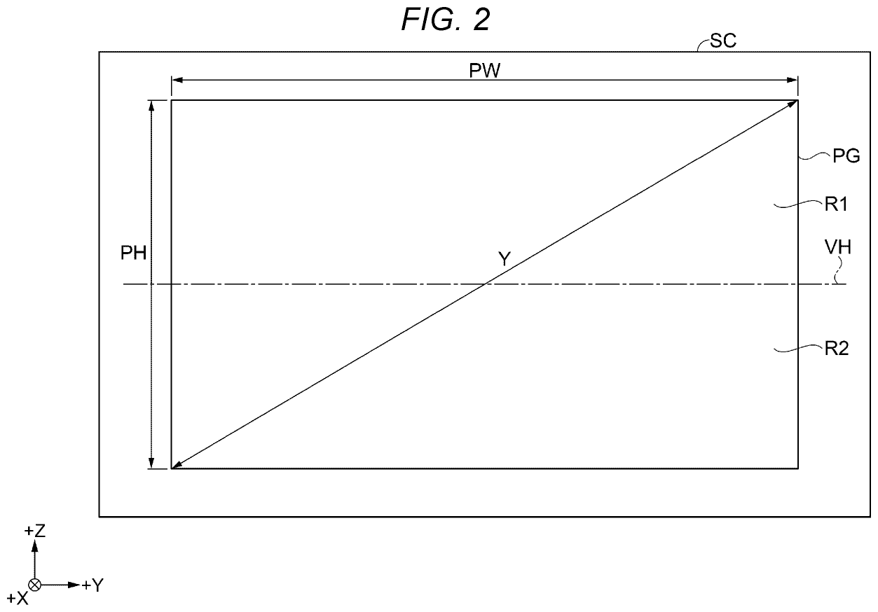

FIG. 2 shows a schematic configuration of the projection image PG projected onto the projection surface SC. FIG. 2 shows the projection image PG having an aspect ratio of a:b. The aspect ratio is a ratio of a long side to a short side of the projection image PG, and a and b are integers representing the aspect ratio. The aspect ratio is, for example, 4:3, 16:9, or 16:10. An image width PW of the projection image PG shown in FIG. 2 is a length of the long side of the projection image PG projected onto the projection surface SC. An image height PH of the projection image PG shown in FIG. 2 is a length of the short side of the projection image PG projected onto the projection surface SC. The projection image PG projected onto the projection surface SC has a rectangular shape. A diagonal line length Y is a length of a diagonal line of the projection image PG projected onto the projection surface SC. The image width PW, the image height PH, and the diagonal line length Y of the projection image PG projected onto the projection surface SC are examples of the length of the projection image PG projected onto the projection surface SC. FIG. 2 shows a virtual horizontal line VH. The virtual horizontal line VH is a line parallel to the long side passing through a center of the projection image PG. A region above the virtual horizontal line VH is represented as a first region R1. A region below the virtual horizontal line VH is represented as a second region R2.

A plurality of drawings including FIG. 2 show an XYZ coordinate system. An X axis is an axis orthogonal to the projection surface SC. A +X direction is a direction from a front side to a back side toward the projection surface SC. A −X direction is a direction from the back side to the front side toward the projection surface SC. A Y axis is an axis parallel to the long side of the projection image PG. A +Y direction is a direction from a left side to a right side toward the projection surface SC. A −Y direction is a direction from the right side to the left side toward the projection surface SC. A Z axis is an axis orthogonal to the Y axis in the projection surface SC, and is parallel to the short side of the projection image PG. A +Z direction is a +Z direction in a left-hand system. In the example in FIG. 2, when the projection image PG is a horizontally long image, the +Z direction is a direction from a lower side toward an upper side of the projection image PG. A −Z direction is a direction from the upper side toward the lower side in FIG. 2.

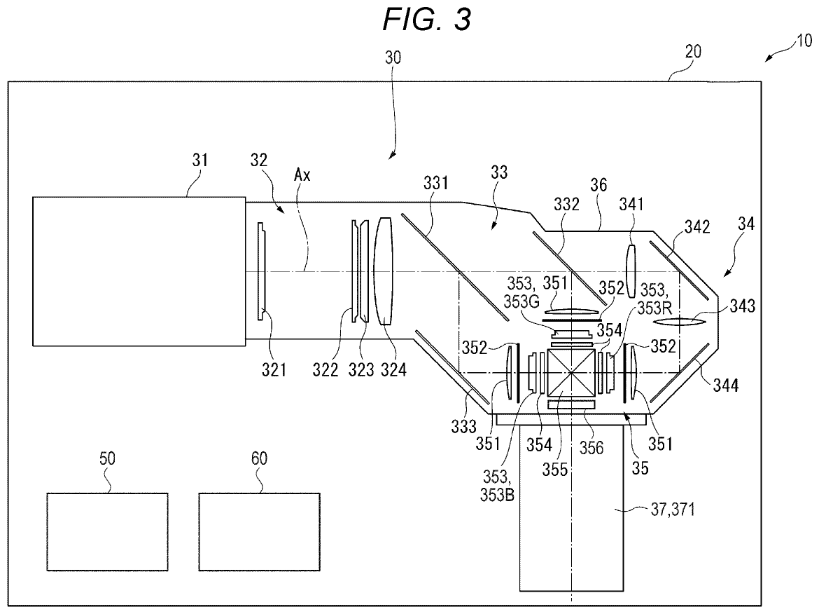

FIG. 3 shows a schematic configuration of the projector 10. The projector 10 projects a projection image PG onto a projection surface SC. The projector 10 includes an exterior housing 20, an image-projecting device 30, a power supply unit 50, and a controller 60.

The exterior housing 20 houses at least a part of the image-projecting device 30, the power supply unit 50, and the controller 60. A slit, the operation panel 11, and the like are provided in the exterior housing 20. The slit is an opening for taking in outside air into the exterior housing 20.

The image-projecting device 30 forms image light according to image information input from an external device. The image-projecting device 30 enlarges and projects the image light onto the projection surface SC. The image-projecting device 30 includes a light source unit 31, an uniformization optical system 32, a color separation optical system 33, a relay optical system 34, an image formation unit 35, an optical component housing 36, and a projection optical unit 37. The image-projecting device 30 corresponds to an example of an optical device.

The light source unit 31 emits light to the uniformization optical system 32. The light source unit 31 includes, for example, a solid-state light source and a wavelength conversion element. The solid-state light source emits blue light that is excitation light. The wavelength conversion element converts at least a part of the blue light emitted from the solid-state light source into fluorescence containing green light and red light. The light source unit 31 may include a light source lamp such as an ultra-high-pressure mercury lamp. The light source unit 31 may include light-emitting elements that individually emit the blue light, the green light, and the red light. The light source unit 31 corresponds to an example of a light source.

The uniformization optical system 32 makes light emitted from the light source unit 31 uniform. The uniform light illuminates a modulation region of a transmissive liquid crystal panel 353 via the color separation optical system 33 and the relay optical system 34. The transmissive liquid crystal panel 353 will be described later. The uniformization optical system 32 includes a first lens array 321, a second lens array 322, a polarization conversion element 323, and a superimposed lens 324.

The first lens array 321 splits the light emitted from the light source unit 31 into a plurality of partial light fluxes. The first lens array 321 is implemented by a plurality of first lenses. The first lens is not shown. The plurality of first lenses are arranged in an array shape on one plane.

The second lens array 322 is implemented by a plurality of second lenses corresponding to the plurality of first lenses. The second lens is not shown. The plurality of second lenses are arranged in an array shape on one plane.

The polarization conversion element 323 converts light into linearly polarized light having a specific vibration direction. The polarization conversion element 323 converts the other linearly polarized light into one linearly polarized light. For example, the polarization conversion element 323 converts P-polarized light into S-polarized light.

The superimposed lens 324 condenses partial light fluxes from the polarization conversion element 323. The superimposed lens 324 superimposes the condensed partial light fluxes near the transmissive liquid crystal panel 353. The first lens array 321, the second lens array 322, and the superimposed lens 324 constitute an integrator optical system that makes an in-plane light intensity distribution of light uniform.

The color separation optical system 33 separates light incident from the uniformization optical system 32 into light of various colors including the red light, the green light, and the blue light. The color separation optical system 33 includes a first dichroic mirror 331, a second dichroic mirror 332, and a first reflection mirror 333.

The first dichroic mirror 331 separates the light into the blue light and light obtained by mixing the red light with the green light. The first dichroic mirror 331 reflects the blue light. The first dichroic mirror 331 transmits the red light and the green light.

The second dichroic mirror 332 separates the light obtained by mixing the red light and the green light into the red light and the green light. The second dichroic mirror 332 reflects the green light. The second dichroic mirror 332 transmits the red light. The second dichroic mirror 332 reflects the green light toward the transmissive liquid crystal panel 353.

The first reflection mirror 333 reflects the blue light separated by the first dichroic mirror 331. The first reflection mirror 333 is disposed in an optical path of the blue light. The first reflection mirror 333 reflects the blue light toward the transmissive liquid crystal panel 353.

The relay optical system 34 is provided in an optical path of the red light. The optical path of the red light is longer than an optical path of the blue light and an optical path of the green light. The relay optical system 34 prevents a loss of the red light. The relay optical system 34 includes an incident-side lens 341, a second reflection mirror 342, a relay lens 343, and a third reflection mirror 344.

The incident-side lens 341 prevents an optical loss of the red light. The incident-side lens 341 causes the red light transmitted by the second dichroic mirror 332 to pass through. The incident-side lens 341 is provided between the second dichroic mirror 332 and the second reflection mirror 342.

The second reflection mirror 342 reflects the red light that passes through the incident-side lens 341. The second reflection mirror 342 reflects the red light toward the relay lens 343. The second reflection mirror 342 is provided between the incident-side lens 341 and the relay lens 343 in the optical path of the red light.

The relay lens 343 prevents the optical loss of the red light. The relay lens 343 causes the red light reflected by the second reflection mirror 342 to pass through. The relay lens 343 is provided between the second reflection mirror 342 and the third reflection mirror 344.

The third reflection mirror 344 reflects the red light that passes through the relay lens 343. The third reflection mirror 344 reflects the red light toward the transmissive liquid crystal panel 353. The third reflection mirror 344 is provided between the relay lens 343 and the transmissive liquid crystal panel 353 in the optical path of the red light.

The relay optical system 34 shown in FIG. 3 is provided in the optical path of the red light and guides the red light. The relay optical system 34 is not limited to the configuration shown in FIG. 3. In the image-projecting device 30, the optical path of the blue light may be longer than the optical path of the red light and the optical path of the green light. At this time, the relay optical system 34 may guide the blue light.

The image formation unit 35 modulates the red light, the green light, and the blue light. The image formation unit 35 forms the image light by combining the modulated red light, green light, and blue light. The image formation unit 35 includes three field lenses 351, three incident-side polarization plates 352, three transmissive liquid crystal panels 353, three emission-side polarization plates 354, one color combination optical system 355, and an optical path shift module 356. The three field lenses 351, the three incident-side polarization plates 352, and the three transmissive liquid crystal panels 353 are respectively provided corresponding to the incident red light, green light, and blue light.

The field lens 351 collimates a principal ray of the incident light. The field lens 351 where the red light is incident collimates a principal ray of the red light. The field lens 351 where the green light is incident collimates a principal ray of the green light. The field lens 351 where the blue light is incident collimates a principal ray of the blue light.

The incident-side polarization plate 352 adjusts polarization of each color light that passes through the field lens 351. The incident-side polarization plate 352 is provided between the field lens 351 and the transmissive liquid crystal panel 353.

The transmissive liquid crystal panel 353 modulates the light emitted from the light source unit 31 based on an image signal input from an external device. The transmissive liquid crystal panel 353 modulates light incident from the incident-side polarization plate 352 according to the image signal. The transmissive liquid crystal panel 353 emits the modulated light. The three transmissive liquid crystal panels 353 are a red-light transmissive liquid crystal panel 353R, a green-light transmissive liquid crystal panel 353G, and a blue-light transmissive liquid crystal panel 353B. The red-light transmissive liquid crystal panel 353R modulates the red light incident from the incident-side polarization plate 352 according to the image signal. The red-light transmissive liquid crystal panel 353R emits the modulated red light. The green-light transmissive liquid crystal panel 353G modulates the green light incident from the incident-side polarization plate 352 according to the image signal. The green-light transmissive liquid crystal panel 353G emits the modulated green light. The blue-light transmissive liquid crystal panel 353B modulates the blue light incident from the incident-side polarization plate 352 according to the image signal. The blue-light transmissive liquid crystal panel 353B emits the modulated blue light.

The transmissive liquid crystal panel 353 includes a plurality of pixels arranged along a first axis corresponding to the Y axis and a second axis corresponding to the Z axis. Depending on the aspect ratio of the projection image PG, pixels corresponding to the aspect ratio operate.

The color combination optical system 355 combines the three color light modulated by the blue-light transmissive liquid crystal panel 353B, the green-light transmissive liquid crystal panel 353G, and the red-light transmissive liquid crystal panel 353R to form the image light. The image light formed by the color combination optical system 355 is incident on the projection optical unit 37. The color combination optical system 355 shown in FIG. 3 is implemented by a substantially rectangular parallelepiped cross dichroic prism. The color combination optical system 355 may be implemented by a plurality of dichroic mirrors.

The optical path shift module 356 shifts the optical path of the image light formed by the color combination optical system 355. The optical path shift module 356 is disposed between the color combination optical system 355 and the projection optical unit 37. The optical path shift module 356 increases resolution of the projection image PG projected onto the projection surface SC by shifting the optical path of the image light. The optical path shift module 356 includes, for example, two sets of actuators (not shown). The optical path shift module 356 swings about two swing axes by operations of the two sets of actuators. The two swing axes are axes orthogonal to each other. The actuator is implemented by a magnet and a coil.

The optical component housing 36 houses the uniformization optical system 32, the color separation optical system 33, the relay optical system 34, and the image formation unit 35 therein. A designed optical axis Ax is set in the image-projecting device 30. The optical component housing 36 holds the uniformization optical system 32, the color separation optical system 33, the relay optical system 34, and the image formation unit 35 at predetermined positions on the optical axis Ax. The light source unit 31 and the projection optical unit 37 are disposed at predetermined positions on the optical axis Ax.

The projection optical unit 37 projects the image light incident from the image formation unit 35 onto the projection surface SC. The projection optical unit 37 includes a lens barrel 371. The lens barrel 371 houses, for example, a plurality of lenses (not shown). The projection optical unit 37 is implemented by a group lens including a plurality of lenses.

At least a part of the projection optical unit 37 may be attachable or detachable to or from the image-projecting device 30. When at least a part of the projection optical unit 37 is removed from the image-projecting device 30, the image-projecting device 30 including the projection optical unit 37 remaining in the image-projecting device 30 corresponds to an example of an optical device. When the entire projection optical unit 37 is removed, the image-projecting device 30 excluding the projection optical unit 37 corresponds to an example of the optical device.

The image-projecting device 30 shown in FIG. 3 is a configuration using the transmissive liquid crystal panel 353, but is not limited to the configuration. The image-projecting device 30 may be a configuration including one or more digital micromirror devices (DMDs).

The power supply unit 50 supplies power to the image-projecting device 30, the controller 60, and the like. The power supply unit 50 causes the light source unit 31 to emit light by supplying the power to the image-projecting device 30. The power supply unit 50 supplies the power for driving the transmissive liquid crystal panels 353. The power supply unit 50 causes the controller 60 to execute various controls by supplying the power to the controller 60.

The controller 60 is a controller that controls the projector 10. The controller 60 is, for example, a processor including a central processing unit (CPU). The controller 60 is implemented by one or more processors. The controller 60 may include a semiconductor memory such as a read only memory (ROM) or a random access memory (RAM). The semiconductor memory functions as a work area of the controller 60. The controller 60 corresponds to an example of a processing device.

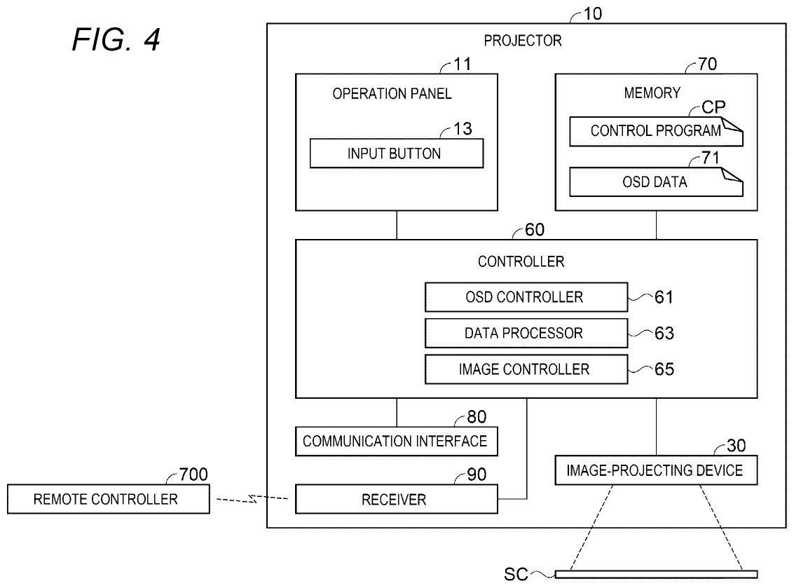

FIG. 4 shows a block configuration of the projector 10. FIG. 4 shows the projector 10 and the remote controller 700. The projector 10 communicates with the remote controller 700 by the infrared communication or the Bluetooth communication.

The projector 10 includes the operation panel 11, the image-projecting device 30, the controller 60, a memory 70, a communication interface 80, and a receiver 90. In FIG. 4, the power supply unit 50 is omitted.

The operation panel 11 includes the plurality of input buttons 13. The plurality of input buttons 13 include, for example, a menu button, a return button, a determination button, a selection button, an adjustment button, and an initial value button. The user appropriately selects a desired input button 13 from the plurality of input buttons 13, and performs an input operation on the input button 13. The operation panel 11 receives an operation from the user.

The image-projecting device 30 projects the projection image PG onto the projection surface SC based on the control of the controller 60. The image-projecting device 30 projects the projection image PG onto the projection surface SC based on the image data transmitted from the image-providing device 500. The image-projecting device 30 projects an OSD image 100 onto the projection surface SC. The OSD is an abbreviation for an on-screen display. The OSD image 100 is displayed in the projection image PG. The OSD image 100 displays settings, operation information, and the like of the projector 10. Details of the OSD image 100 will be described later.

The controller 60 functions as various functional units by executing a control program CP. The control program CP is stored in the memory 70. The controller 60 functions as an OSD controller 61, a data processor 63, and an image controller 65 by executing the control program CP.

The OSD controller 61 is a functional unit that displays various OSD images 100 in the projection image PG. The OSD controller 61 causes various OSD images 100 to be displayed based on OSD data 71. The OSD data 71 is stored in the memory 70. The OSD image 100 includes a measurement image 101. The measurement image 101 corresponds to an example of a first image. The OSD image 100 may include any of various messages, an image indicating an operation, an input data image, and the like.

The data processor 63 calculates size data based on input data input by the user. The size data is a length of the projection image PG projected onto the projection surface SC. The size data is calculated by the data processor 63. The size data is, for example, the diagonal line length Y of the projection image PG projected onto the projection surface SC. The size data may be either the image height PH or the image width PW. The image height PH is a length of a side along the Z axis of the projection image PG projected onto the projection surface SC. The image width PW is a length of a side along the Y axis of the projection image PG projected onto the projection surface SC. When the size data is either the image height PH or the image width PW, a size of the projection image PG projected onto the projection surface SC is calculated by either the image height PH or the image width PW and the aspect ratio. The length of the projection image PG projected onto the projection surface SC corresponds to an example of a third length. The size data that is the length of the projection image PG projected onto the projection surface SC corresponds to an example of information indicating the third length.

The data processor 63 outputs the size data. The data processor 63 outputs the size data to the OSD controller 61. The size data is input to the OSD controller 61. The OSD controller 61 causes an input data image and the like included in the OSD image 100 to be displayed in the projection image PG based on the size data. The data processor 63 may output the size data to an external device via the communication interface 80. The data processor 63 may output the size data to the memory 70. The memory 70 stores the size data.

The image controller 65 performs image processing on image data transmitted from the image-providing device 500. The image controller 65 corrects the image data by using various setting values. The various setting values are stored in the memory 70. The setting value is an aspect ratio, contrast, brightness, a correction value related to a geometric distortion correction, or the like. The image controller 65 may perform image processing of superimposing the OSD image 100 on an image based on the image data and causing the OSD image 100 to be displayed on the image.

The memory 70 stores various pieces of data. The memory 70 is implemented by a RAM, a ROM, and the like. The memory 70 stores the control program CP and the OSD data 71. The memory 70 stores the various setting values used by the image controller 65, the size data calculated by the data processor 63, and the like.

The control program CP is firmware that causes the controller 60 to function as various functional units. The control program CP causes the controller 60 to operate as the OSD controller 61, the data processor 63, and the image controller 65. The control program CP may cause the controller 60 to operate as a functional unit other than the OSD controller 61, the data processor 63, and the image controller 65. The control program CP corresponds to an example of a program.

The OSD data 71 is various pieces of data related to the OSD image 100 displayed in the projection image PG. The OSD data 71 includes ratio data. The ratio data is, for example, a width ratio that is a ratio of a width of the measurement image 101 to a width of the projection image PG. The ratio data is not limited to the width ratio. The ratio data may be a height ratio that is a ratio of a height of the measurement image 101 to a height of the projection image PG. The ratio data may be a diagonal line ratio that is a ratio of a length of a diagonal line of the measurement image 101 to a length of the diagonal line of the projection image PG. The length of the diagonal line, the width, and the height of the projection image PG are collectively referred to as an image size. The image size corresponds to an example of a first length. The ratio data corresponds to an example of a known length relationship with respect to the first length.

The ratio data is set in advance and stored in the memory 70. For example, the ratio data is calculated based on the number of pixels of the transmissive liquid crystal panel 353 that operates when generating the image light. The ratio data is a ratio of the number of pixels along the first axis to the number of pixels along the first axis for generating the measurement image 101. The first axis is an axis parallel or substantially parallel to the Y axis. The first axis may be an axis parallel or substantially parallel to the Z axis. The first axis may be an axis parallel or substantially parallel to the diagonal line of the projection image PG. In a case where the number of pixels along the first axis that operate when projecting the projection image PG is n, and the number of pixels along the first axis for generating the measurement image 101 is m, the ratio data is m/n. Here, n is an integer of one or more, and m is an integer of one or more and n or less. The number of pixels along the first axis that operate when projecting the projection image PG corresponds to the width of the projection image PG.

The ratio data may be calculated based on an operation pixel length of the transmissive liquid crystal panel 353 that operates when generating the image light. When the image-projecting device 30 projects the projection image PG onto the projection surface SC, a predetermined number of pixels operate. The number of operating pixels is predetermined based on the aspect ratio. The ratio data is a proportion of a pixel length along the first axis of an operation pixel group that is a set of a predetermined number of pixels to a pixel length along the first axis of a generation pixel group that generates the measurement image 101. The pixel length along the first axis of the operation pixel group corresponds to the length of the projection image PG. The pixel length along the first axis of the operation pixel group corresponds to an example of the first length. The ratio data may be calculated using data other than the number of pixels and the pixel length.

The communication interface 80 is an interface circuit communicably connected with the image-providing device 500. The communication interface 80 is connected to the image-providing device 500 in a wired or wireless manner according to a predetermined communication protocol. The communication interface 80 includes a wired connector and a wireless communication port. The wired connector is a high-definition multimedia interface (HDMI) connector, a universal serial bus (USB) connector, a local area network (LAN) connector, or the like. The wireless communication port is a Wi-Fi communication port, a Bluetooth communication port, or the like. The HDMI, the Wi-Fi, and the Bluetooth are registered trademarks. The communication interface 80 receives the image data from the image-providing device 500. The communication interface 80 transmits various pieces of setting data and the like of the projector 10 to the image-providing device 500 according to a control of the controller 60. The communication interface 80 may transmit the size data to the image-providing device 500. The communication interface 80 may be communicably connected to an external device different from the image-providing device 500. The communication interface 80 transmits various pieces of setting data, the size data, and the like to the external device. The communication interface 80 outputs the size data to the image-providing device 500 or the external device.

The receiver 90 receives an operation signal from the remote controller 700. The receiver 90 is implemented by a reception circuit such as an infrared communication circuit or a Bluetooth communication circuit. The receiver 90 receives the operation signal by the infrared communication or the Bluetooth communication. The operation signal includes a power supply operation signal for operating a power supply of the projector 10, an instruction signal related to the OSD image 100, and the like. The operation signal may include measurement data indicating a measurement result of the measurement image 101. The receiver 90 transmits the operation signal to the controller 60. The controller 60 performs various controls based on the operation signal. The receiver 90 corresponds to an example of an input device.

The remote controller 700 transmits the operation signal to the receiver 90. When the user performs an input operation on any of the plurality of operation buttons 710 provided on the remote controller 700, the remote controller 700 transmits the operation signal to the receiver 90. The remote controller 700 transmits an operation signal corresponding to each of the plurality of operation buttons 710 to the receiver 90.

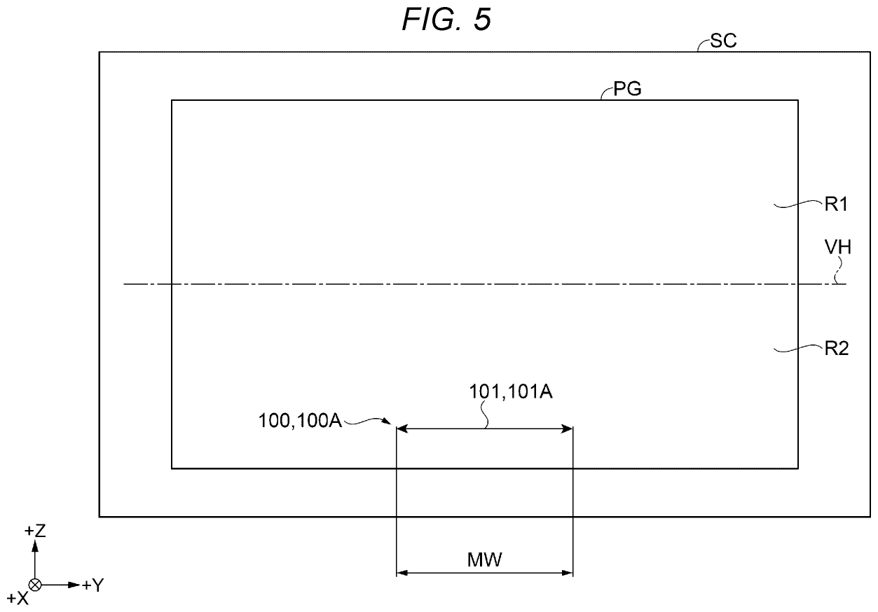

FIG. 5 shows an example of the projection image PG including the OSD image 100. FIG. 5 shows the projection image PG projected onto the projection surface SC. The projection image PG shown in FIG. 5 includes a first OSD image 100A. The first OSD image 100A is an example of the OSD image 100. The aspect ratio of the projection image PG shown in FIG. 5 is a:b. FIG. 5 shows a first measurement image 101A as the first OSD image 100A. The first measurement image 101A is an example of the measurement image 101. FIG. 5 shows the virtual horizontal line VH. The first measurement image 101A that is the measurement image 101 is an image that prompts the user to measure a measured image width MW of the first measurement image 101A. The user measures the measured image width MW of the first measurement image 101A displayed in the projection image PG. The user inputs a measurement result of the measured image width MW to the projector 10.

The first measurement image 101A is a line of a bidirectional arrow. The first measurement image 101A is disposed to be parallel or substantially parallel to the Y axis. The first measurement image 101A is disposed to be parallel or substantially parallel to the long side of the projection image PG. The first measurement image 101A shown in FIG. 5 is displayed in the second region R2 of the projection image PG. The first measurement image 101A is the line of the bidirectional arrow, but is not limited to the form. The form of the measurement image 101 may be any form as long as a length in a predetermined direction such as a width or a height can be measured.

The user measures the measured image width MW of the first measurement image 101A on the projection surface SC, and inputs a measurement result to the projector 10. That is, the measured image width MW of the first measurement image 101A currently projected onto the projection surface SC is measured using a measurement instrument or the like. The measurement result is a length of the first measurement image 101A projected onto the projection surface SC. The measured image width MW is an example of a length of the first image projected onto the projection surface SC. The measurement result of the measured image width MW corresponds to an example of a second length. The user inputs the measurement result by using the operation panel 11 or the remote controller 700. The projector 10 acquires measurement data indicating the measurement result. The data processor 63 of the projector 10 calculates the size data of the projection image PG by using the measurement result. The data processor 63 calculates the diagonal line length Y that is an example of the size data by using the following Equation (1).

$$Y = \sqrt{{( cX )}^{2} \times ( 1 + {( \frac{b}{a} )}^{2} )} \qquad ( 1 )$$

Here, c is ratio data. When the measurement image 101 is the first measurement image 101A, a width ratio is used as the ratio data. X is a measured value of the measured image width MW input by the user, and a and b are values representing the aspect ratio. The data processor 63 can calculate the diagonal line length Y by substituting the measurement data into Equation (1). The data processor 63 outputs the diagonal line length Y as the size data to the OSD controller 61, the image-providing device 500, and the like.

The data processor 63 may calculate the image width PW as the size data. The image width PW is calculated by multiplying the measured value of the measured image width MW measured by the user by the ratio data.

The OSD controller 61 adjusts sizes of various images included in the OSD image 100 when inputting the size data. The OSD controller 61 adjusts a size of an image in the OSD image 100 different from the first measurement image 101A based on the size data. For example, the OSD controller 61 adjusts a size of a projector setting image. The projector setting image is displayed in the projection image PG as the OSD image 100. The projector setting image is a screen where various setting values related to an operation of the projector can be set. The user adjusts a contrast ratio, an image color, a resolution, and the like by using the projector setting image. When the size of the projector setting image is adjusted based on the size data, the user easily visually recognizes the projector setting image. A size of the first measurement image 101A is maintained at a size before the size data is input.

The image-providing device 500 may correct the image data to be transmitted to the projector 10 when the size data is input. The image-providing device 500 corrects the image data by using the size data. For example, the image-providing device 500 adjusts a size of a partial image included in the projection image PG displayed on the projection surface SC based on the image data. The partial image is an insert image showing a face of a person or the like. The image-providing device 500 can cause a size of the partial image to be displayed in the projection image PG in a size close to an actual dimension by adjusting the size of the partial image.

A position where the first measurement image 101A is displayed is appropriately adjusted. The first measurement image 101A may be disposed in the second region R2. The second region R2 is a lower region when the projection image PG is horizontally divided into two equal parts. When the first measurement image 101A is displayed in the second region R2, the user easily measures the measured image width MW of the first measurement image 101A.

When the projection image PG is horizontally divided into two equal parts, the first measurement image 101A may be disposed in a lower region.

When the first measurement image 101A is disposed in the second region R2, the user easily accesses the first measurement image 101A. The user easily measures the measured image width MW of the first measurement image 101A.

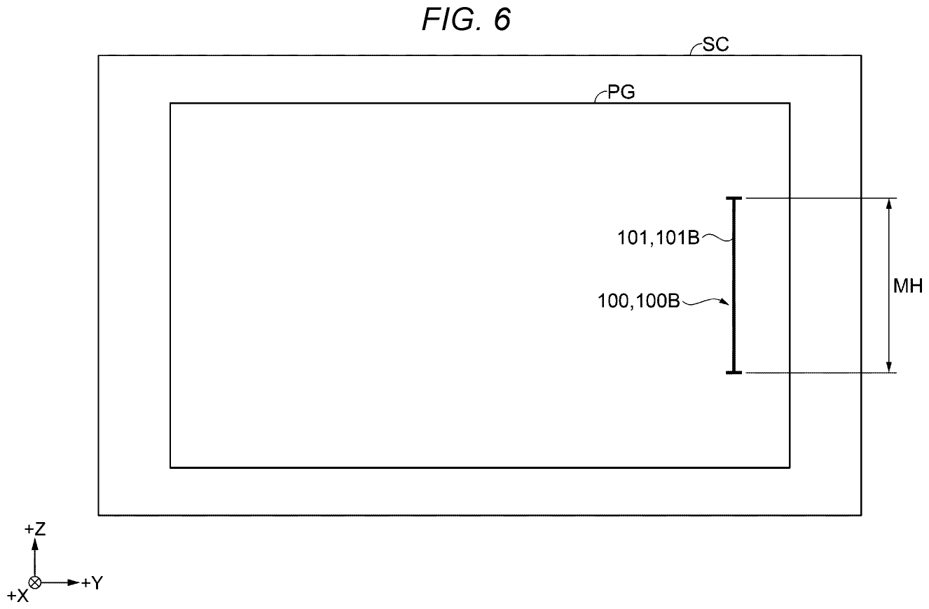

FIG. 6 shows an example of the projection image PG including the OSD image 100. FIG. 6 shows the projection image PG projected onto the projection surface SC. The projection image PG shown in FIG. 6 includes a second OSD image 100B. The second OSD image 100B is an example of the OSD image 100. The aspect ratio of the projection image PG shown in FIG. 6 is a:b. FIG. 6 shows a second measurement image 101B as the second OSD image 100B. The second measurement image 101B is an example of the measurement image 101. The second measurement image 101B is an image that prompts the user to measure a measured image height MH of the second measurement image 101B. The user measures the measured image height MH of the second measurement image 101B displayed on the projection surface SC. The measured image height MH is an example of a length of the first image projected onto the projection surface SC. A measurement result of the measured image height MH corresponds to an example of the second length. The user inputs the measurement result of the measured image height MH to the projector 10.

The second measurement image 101B is implemented by a straight line parallel or substantially parallel to the Z axis, and end emphasis lines disposed at both ends of the straight line. The straight line of the second measurement image 101B is disposed to be parallel or substantially parallel to the short side of the projection image PG. The second measurement image 101B shown in FIG. 6 is displayed in a region closer to an outer edge of the projection image PG than a center of the projection image PG.

The user measures the measured image height MH of the second measurement image 101B, and inputs a measurement result to the projector 10. The user inputs the measurement result by using the operation panel 11 or the remote controller 700. The projector 10 acquires measurement data indicating the measurement result. The data processor 63 of the projector 10 calculates the size data of the projection image PG by using the measurement result. The data processor 63 calculates the diagonal line length Y that is an example of the size data by using Equation (1). At this time, a height ratio is used as the ratio data. Measurement data that is a measurement result of the measured image height MH is substituted into X in Equation (1).

The data processor 63 may calculate the image height PH as the size data. The image height PH is calculated by multiplying a measured value of the measured image height MH measured by the user by the height ratio serving as the ratio data.

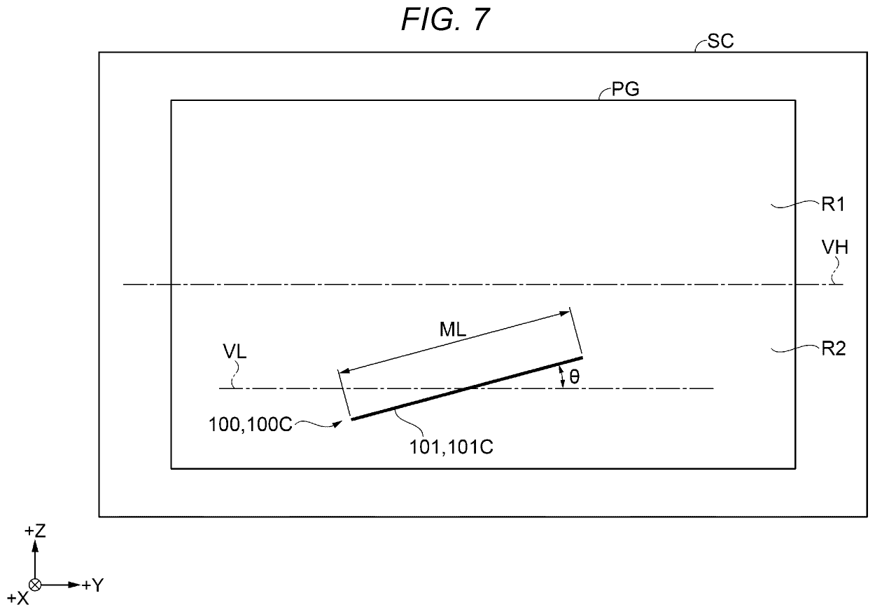

FIG. 7 shows an example of the projection image PG including the OSD image 100. FIG. 7 shows the projection image PG projected onto the projection surface SC. The projection image PG shown in FIG. 7 includes a third OSD image 100C. The third OSD image 100C is an example of the OSD image 100. The aspect ratio of the projection image PG shown in FIG. 7 is a:b. FIG. 7 shows a third measurement image 101C as the third OSD image 100C. The third measurement image 101C is an example of the measurement image 101. The third measurement image 101C is an image that prompts the user to measure a measured image length ML of the third measurement image 101C. The user measures the measured image length ML of the third measurement image 101C displayed on the projection surface SC. The measured image length ML is an example of the length of the first image projected onto the projection surface SC. A measurement result of the measured image length ML corresponds to an example of the second length. The measured image width MW, the measured image height MH, and the measured image length ML are collectively referred to as the length of the measurement image 101. The user inputs the measurement result of the measured image length ML to the projector 10.

The third measurement image 101C is a diagonal line having an inclined angle θ with respect to a virtual line VL. The virtual line VL is a virtual line parallel to the Y axis. The third measurement image 101C shown in FIG. 7 is disposed in the second region R2.

The user measures the measured image length ML of the third measurement image 101C, and inputs a measurement result to the projector 10. The user inputs the measurement result by using the operation panel 11 or the remote controller 700. The projector 10 acquires measurement data indicating the measurement result. The data processor 63 of the projector 10 calculates the size data of the projection image PG by using the measurement result. For example, the data processor 63 calculates a Y-axis length of the measured image length ML. The Y-axis length is calculated using the measured image length ML and the inclined angle θ. The data processor 63 calculates the diagonal line length Y that is an example of the size data by using Equation (1). At this time, the Y-axis length of the measured image length ML is substituted into X. A Y-axis length ratio that is a proportion of a Y-axis length of the measurement image 101 to the image width PW of the projection image PG is used for the ratio data.

The data processor 63 may calculate the image width PW as the size data. The image width PW is calculated by multiplying the Y-axis length of the measured image length ML measured by the user by the Y-axis length ratio.

The inclination of the third measurement image 101C may be set to be the same or substantially the same as an inclination of the diagonal line of the projection image PG. When the inclination of the third measurement image 101C is the same as the inclination of the diagonal line of the projection image PG, the diagonal line length Y is calculated by multiplying the measured image length ML by the diagonal line ratio.

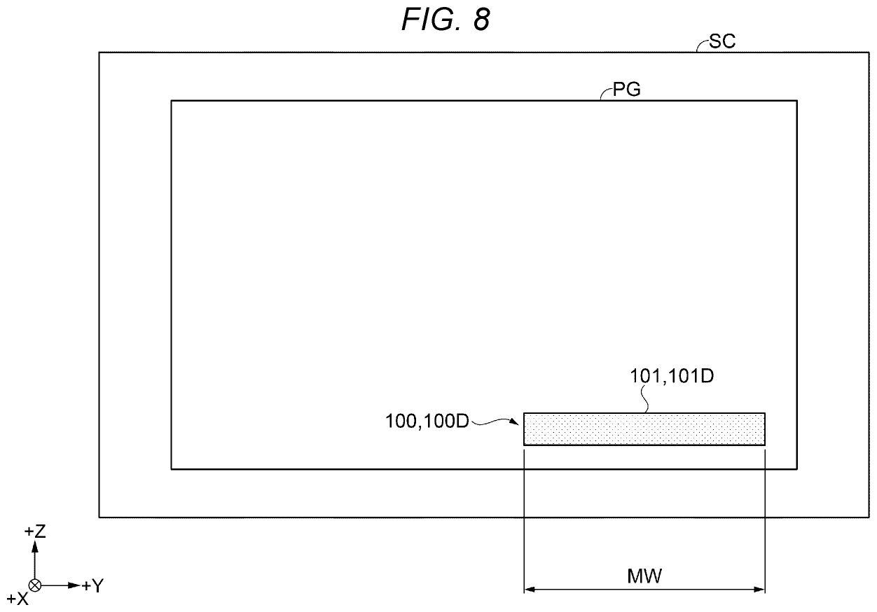

FIG. 8 shows an example of the projection image PG including the OSD image 100. FIG. 8 shows the projection image PG projected onto the projection surface SC. The projection image PG shown in FIG. 8 includes a fourth OSD image 100D. The fourth OSD image 100D is an example of the OSD image 100. The aspect ratio of the projection image PG shown in FIG. 8 is a:b. FIG. 8 shows a fourth measurement image 101D as the fourth OSD image 100D. The fourth measurement image 101D is an example of the measurement image 101. The fourth measurement image 101D is an image that prompts the user to measure the measured image width MW of the fourth measurement image 101D. The user measures the measured image width MW of the fourth measurement image 101D displayed on the projection surface SC. The user inputs a measurement result of the measured image width MW to the projector 10.

The fourth measurement image 101D is a rectangular image. The fourth measurement image 101D is disposed such that a long side is parallel or substantially parallel to the Y axis. The fourth measurement image 101D is disposed to be parallel or substantially parallel to the long side of the projection image PG.

The user measures the measured image width MW of the fourth measurement image 101D, and inputs a measurement result to the projector 10. The user inputs the measurement result by using the operation panel 11 or the remote controller 700. The projector 10 acquires measurement data indicating the measurement result. The data processor 63 of the projector 10 calculates the size data of the projection image PG by using the measurement data. The data processor 63 calculates the diagonal line length Y that is an example of the size data by using Equation (1).

The data processor 63 may calculate the image width PW as the size data. The image width PW is calculated by multiplying a measured value of the measured image width MW measured by the user by the width ratio as the ratio data.

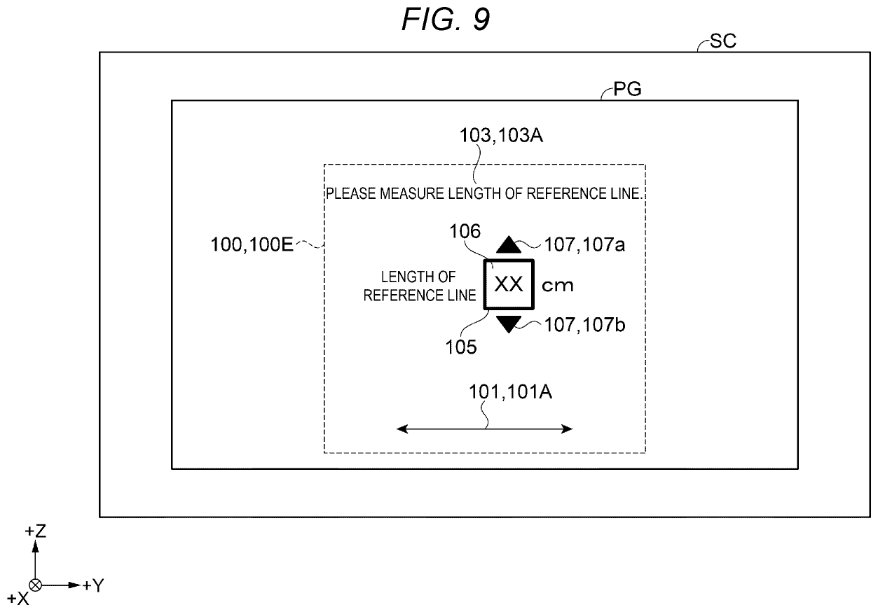

FIG. 9 shows an example of the projection image PG including the OSD image 100. FIG. 9 shows the projection image PG projected onto the projection surface SC. The projection image PG shown in FIG. 9 includes a fifth OSD image 100E. The fifth OSD image 100E is an example of the OSD image 100. The aspect ratio of the projection image PG shown in FIG. 9 is a:b. The fifth OSD image 100E includes the first measurement image 101A, a first message image 103A, an input value display icon 105, and an operation button icon 107. The first measurement image 101A is an image that prompts the user to measure the measured image width MW of the first measurement image 101A. The user measures the measured image width MW of the first measurement image 101A displayed on the projection surface SC. The user inputs a measurement result of the measured image width MW to the projector 10.

The first measurement image 101A shown in FIG. 9 is the same as the first measurement image 101A shown in FIG. 5. The fifth OSD image 100E includes the first measurement image 101A, but is not limited thereto. The fifth OSD image 100E may include the second measurement image 101B, the third measurement image 101C, or the fourth measurement image 101D instead of the first measurement image 101A.

The first message image 103A is an image displaying information to be notified to the user. The first message image 103A is an example of a message image 103. The first message image 103A is a message that prompts the user to measure the measured image width MW of the first measurement image 101A. In the first message image 103A, the first measurement image 101A is represented as a reference line. A text of the message image 103 is appropriately set.

The input value display icon 105 is an icon image for receiving an input of an input value 106. The input value display icon 105 receives the input of the input value 106 when selected by the user. The user measures the measured image width MW of the first measurement image 101A projected onto the projection surface SC. The user inputs a measurement result of the measured image width MW as the input value 106. The input value 106 corresponds to the second length. When the user operates a predetermined input button 13 in the operation panel 11 or a predetermined operation button 710 in the remote controller 700, the input value display icon 105 is selected. The input value display icon 105 receives an input of the input value 106 when in a selected state. When the user inputs the input value 106 by using the operation button icon 107, the input value display icon 105 displays the input value 106. The fifth OSD image 100E receives an input of the input value 106 via the operation button icon 107 and the input value display icon 105. The operation button icon 107 and the input value display icon 105 correspond to an example of a user interface image.

The operation button icon 107 is an icon image for receiving an input or a change of the size data. The operation button icon 107 receives an input operation when selected by the user. The operation button icon 107 includes, for example, a first operation button icon 107a and a second operation button icon 107b.

The first operation button icon 107a increases the input value 106 displayed on the input value display icon 105. The user increases the input value 106 by operating the first operation button icon 107a. Every time the first operation button icon 107a is operated by the user, the input value 106 is increased by, for example, several cm. An increase amount of the input value 106 is appropriately adjusted.

The second operation button icon 107b decreases the input value 106 displayed on the input value display icon 105. The user decreases the input value 106 by operating the second operation button icon 107b. Every time the second operation button icon 107b is operated by the user, the input value 106 is decreased by, for example, several cm. A decrease amount of the input value 106 is appropriately adjusted. The user inputs the input value 106 by using the first operation button icon 107a and the second operation button icon 107b.

The projection image PG further includes the input value display icon 105 for receiving an input of the input value 106. Receiving an input of the input value 106 means receiving the input of the input value 106 via the input value display icon 105.

The user can easily understand that the input value 106 is input to the input value display icon 105 displayed on the projection image PG.

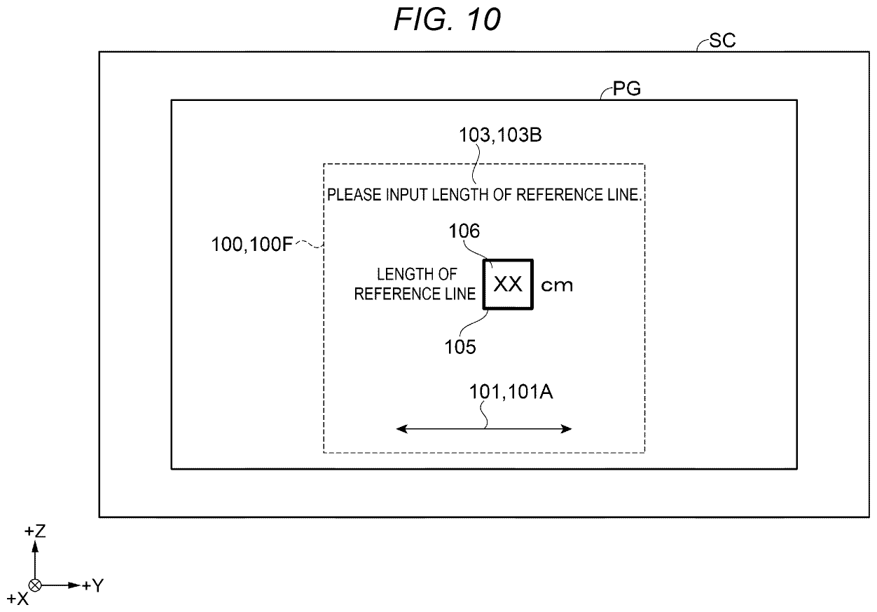

FIG. 10 shows an example of the projection image PG including the OSD image 100. FIG. 10 shows the projection image PG projected onto the projection surface SC. The projection image PG shown in FIG. 10 includes a sixth OSD image 100F. The sixth OSD image 100F is an example of the OSD image 100. The aspect ratio of the projection image PG shown in FIG. 10 is a:b. The sixth OSD image 100F includes the first measurement image 101A, a second message image 103B, and the input value display icon 105. The sixth OSD image 100F is an image that prompts the user to measure the measured image width MW of the first measurement image 101A. The user measures the measured image width MW of the first measurement image 101A displayed on the projection surface SC. The user inputs a measurement result of the measured image width MW to the projector 10.

The first measurement image 101A shown in FIG. 10 is the same as the first measurement image 101A shown in FIG. 5. The sixth OSD image 100F includes the first measurement image 101A, but is not limited thereto. The sixth OSD image 100F may include the second measurement image 101B, the third measurement image 101C, or the fourth measurement image 101D instead of the first measurement image 101A.

The second message image 103B is an image that displays information to be notified to the user. The second message image 103B is an example of the message image 103. The second message image 103B is a message that prompts the user to input a measured value obtained by measuring the measured image width MW of the first measurement image 101A. In the second message image 103B, the first measurement image 101A is represented as a reference line.

The input value display icon 105 is an icon image for receiving an input of an input value 106. The input value display icon 105 receives the input of the input value 106 when selected by the user. When the user operates a predetermined input button 13 in the operation panel 11 or a predetermined operation button 710 in the remote controller 700, the input value display icon 105 is selected. The input value display icon 105 receives an input of the input value 106 when in a selected state. The user inputs a numerical value to the operation panel 11 or the remote controller 700. At this time, an input button 13 for inputting the numerical value is included in the plurality of input buttons 13. Alternatively, an operation button 710 for inputting a numerical value is included in the plurality of operation buttons 710. When the user inputs the input value 106 by using the operation panel 11 or the remote controller 700, the input value display icon 105 displays the input value 106. The sixth OSD image 100F receives an input of the input value 106 via the input value display icon 105.

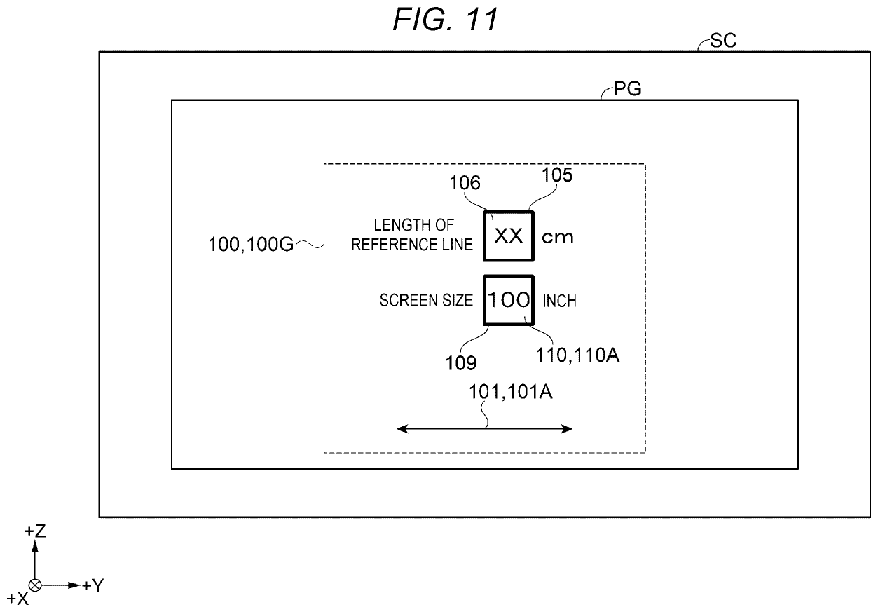

FIG. 11 shows an example of the projection image PG including the OSD image 100. FIG. 11 shows the projection image PG projected onto the projection surface SC. The projection image PG shown in FIG. 11 includes a seventh OSD image 100G. The seventh OSD image 100G is an example of the OSD image 100. The aspect ratio of the projection image PG shown in FIG. 11 is a:b. The seventh OSD image 100G includes the first measurement image 101A, the input value display icon 105, and an output value display icon 109. The seventh OSD image 100G may display the message image 103, the operation button icon 107, and the like. The seventh OSD image 100G is an image that prompts the user to measure the measured image width MW of the first measurement image 101A. The user measures the measured image width MW of the first measurement image 101A displayed on the projection surface SC. The user inputs a measurement result of the measured image width MW to the projector 10.

The first measurement image 101A shown in FIG. 11 is the same as the first measurement image 101A shown in FIG. 5. The seventh OSD image 100G includes the first measurement image 101A, but is not limited thereto. The seventh OSD image 100G may include the second measurement image 101B, the third measurement image 101C, or the fourth measurement image 101D instead of the first measurement image 101A.

The input value display icon 105 shown in FIG. 11 is the same as the input value display icon 105 shown in FIG. 10. The input value display icon 105 shown in FIG. 11 displays the input value 106. The input value 106 is input by the user.

The output value display icon 109 displays an output value 110 representing the size data. The output value display icon 109 shown in FIG. 11 displays a first output value 110A. The first output value 110A is an example of the output value 110. The output value 110 corresponds to an example of a second image. The first output value 110A is output from the data processor 63. The data processor 63 calculates the size data based on the input value 106 input to the input value display icon 105. The data processor 63 causes the size data to be displayed as the first output value 110A in the projection image PG. When the data processor 63 outputs the size data, the projector 10 projects the projection image PG including the first output value 110A onto the projection surface SC by using the image-projecting device 30. The output value display icon 109 displays the first output value 110A based on the input value 106.

The first output value 110A shown in FIG. 11 indicates the diagonal line length Y that is an example of the size data in an inch unit. The first output value 110A is not limited to the diagonal line length Y. The first output value 110A may be a value indicating a size of the projection image PG such as the image width PW or the image height PH. The first output value 110A indicates the diagonal line length Y in the inch unit, but is not limited thereto. The first output value 110A may be displayed in a centimeter unit. The seventh OSD image 100G preferably displays a unit of the first output value 110A.

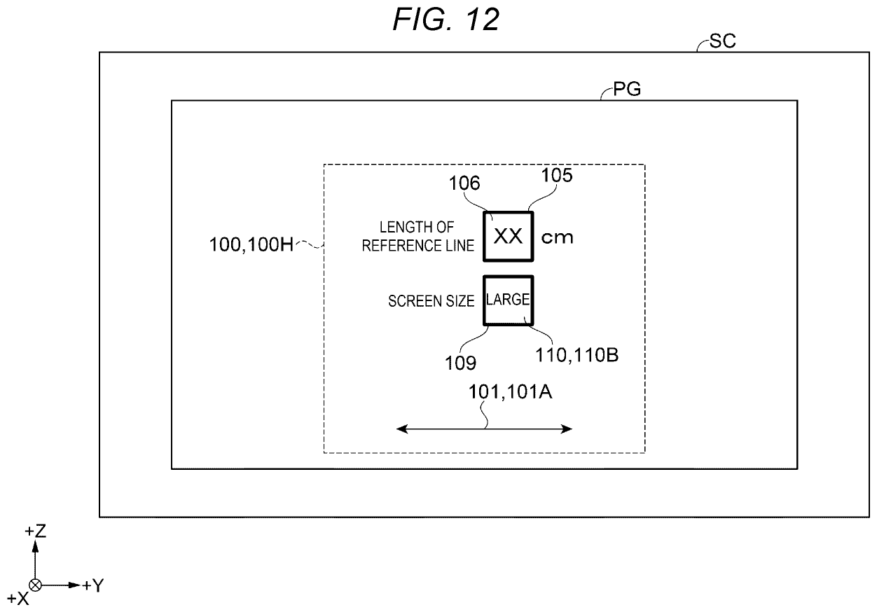

FIG. 12 shows an example of the projection image PG including the OSD image 100. FIG. 12 shows the projection image PG projected onto the projection surface SC. The projection image PG shown in FIG. 12 includes an eighth OSD image 100H. The eighth OSD image 100H is an example of the OSD image 100. The aspect ratio of the projection image PG shown in FIG. 12 is a:b. The eighth OSD image 100H includes the first measurement image 101A, the input value display icon 105, and the output value display icon 109. The eighth OSD image 100H may display the message image 103, the operation button icon 107, and the like. The eighth OSD image 100H is an image that prompts the user to measure the measured image width MW of the first measurement image 101A. The user measures the measured image width MW of the first measurement image 101A displayed on the projection surface SC. The user inputs a measurement result of the measured image width MW to the projector 10.

The first measurement image 101A shown in FIG. 12 is the same as the first measurement image 101A shown in FIG. 5. The eighth OSD image 100H includes the first measurement image 101A, but is not limited thereto. The eighth OSD image 100H may include the second measurement image 101B, the third measurement image 101C, or the fourth measurement image 101D instead of the first measurement image 101A.

The input value display icon 105 shown in FIG. 12 is the same as the input value display icon 105 shown in FIG. 10. The input value display icon 105 shown in FIG. 12 displays the input value 106. The input value 106 is input by the user.

The output value display icon 109 shown in FIG. 12 displays the output value 110 in a mode different from that of the output value display icon 109 shown in FIG. 11. The output value display icon 109 shown in FIG. 12 displays a second output value 110B. The second output value 110B is an example of the output value 110. The second output value 110B represents the size data as “large”. The data processor 63 calculates the size data based on the input value 106 input to the input value display icon 105. For example, the data processor 63 classifies the size data into three groups, and outputs a classified result as the second output value 110B. The three groups are a large size group, a medium size group, and a small size group. The OSD controller 61 outputs a term representing a group as the size data. The number of groups classified by the data processor 63 is not limited to three. The number of groups may be two or more.

Outputting the size data includes projecting the output value 110 representing the size data onto the projection surface SC by using the image-projecting device 30.

The user can confirm a size of the projection image PG projected onto the projection surface SC.

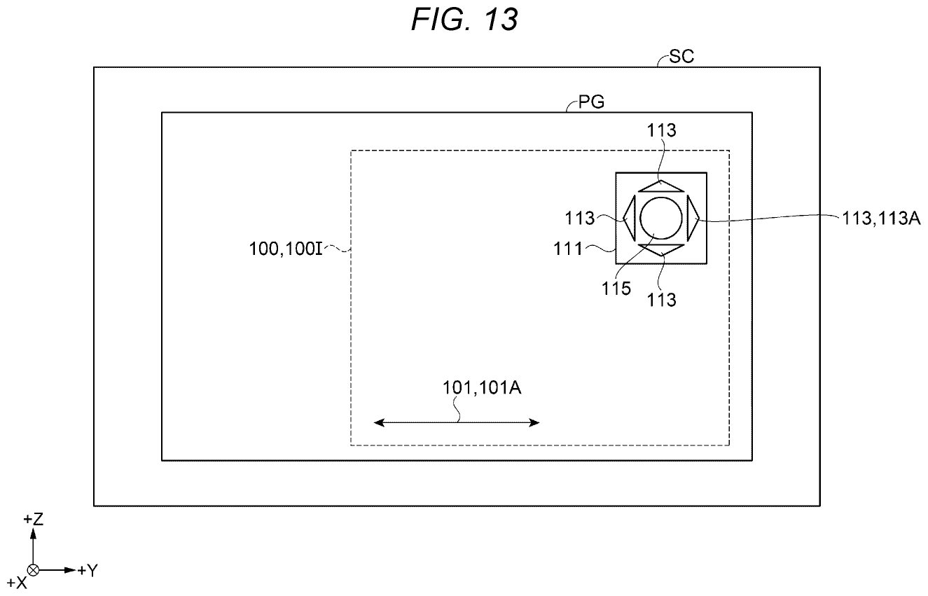

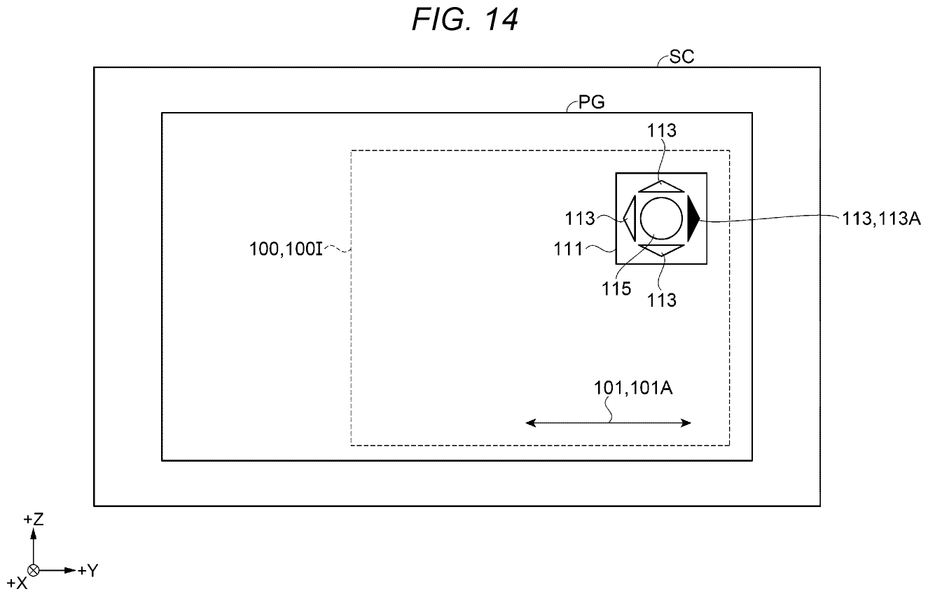

FIGS. 13 and 14 show an example of the projection image PG including the OSD image 100. FIGS. 13 and 14 show the projection image PG projected onto the projection surface SC. The projection image PG shown in FIGS. 13 and 14 includes a ninth OSD image 100I. The ninth OSD image 100I is an example of the OSD image 100. The aspect ratio of the projection image PG shown in FIGS. 13 and 14 is a:b. The ninth OSD image 100I includes the first measurement image 101A and a position operation icon 111. The ninth OSD image 100I may display the message image 103, the input value display icon 105, the operation button icon 107, the output value display icon 109, and the like. The ninth OSD image 100I is an image that prompts the user to measure the measured image width MW of the first measurement image 101A. FIG. 13 shows the ninth OSD image 100I before the user performs a position change operation on the first measurement image 101A. FIG. 14 shows the ninth OSD image 100I after the user performs the position change operation on the first measurement image 101A. The position change operation corresponds to an example of a change operation.

The position operation icon 111 is an icon image showing some of the plurality of input buttons 13 provided at the operation panel 11. The position operation icon 111 may be an icon image showing some of the plurality of operation buttons 710 provided at the remote controller 700. The position operation icon 111 includes a plurality of direction indication button icons 113 and a determination button icon 115. Each of the plurality of direction indication button icons 113 corresponds to the input button 13. Alternatively, each of the plurality of direction indication button icons 113 corresponds to the operation button 710. The position operation icon 111 is an example of the user interface image that receives a change operation of changing a projection position of the first measurement image 101A.

The direction indication button icon 113 indicates a movement direction of the first measurement image 101A. A first direction indication button icon 113A among the plurality of direction indication button icons 113 indicates the +Y direction as the movement direction. When the user inputs the position change operation to the input button 13 corresponding to the first direction indication button icon 113A, the OSD controller 61 moves the first measurement image 101A in the +Y direction. Alternatively, when the user inputs the position change operation to the operation button 710 corresponding to the first direction indication button icon 113A, the OSD controller 61 moves the first measurement image 101A in the +Y direction. When the user inputs the position change operation to the input button 13 corresponding to the direction indication button icon 113 different from the first direction indication button icon 113A, the OSD controller 61 moves the first measurement image 101A in a direction corresponding to the direction indication button icon 113. The operation panel 11 or the remote controller 700 receives the position change operation. The OSD controller 61 changes the projection position of the first measurement image 101A based on the position change operation.

The determination button icon 115 is an icon image corresponding to a determination button among the plurality of input buttons 13 provided at the operation panel 11. Alternatively, the determination button icon 115 is an icon image corresponding to an operation determination button among the plurality of operation buttons 710 provided at the remote controller 700. The determination button and the operation determination button are not shown. When the user performs an operation input to the determination button or the operation determination button, the projection position of the first measurement image 101A is determined.

FIG. 14 shows a state when the user inputs the position change operation to the input button 13 or the operation button 710 corresponding to the first direction indication button icon 113A. The first direction indication button icon 113A shown in FIG. 14 is displayed in a display mode different from those of other direction indication button icons 113. The display mode of the first direction indication button icon 113A is different, whereby the user can confirm the indicated direction. As shown in FIG. 14, the projection position of the first measurement image 101A is moved in the +Y direction based on the position change operation by the user.

The projector 10 includes the operation panel 11 or the remote controller 700 that receives the position change operation of changing the projection position of the first measurement image 101A. The controller 60 changes the projection position of the first measurement image 101A based on the position change operation.

The user can change the projection position of the first measurement image 101A to a position where the measured image width MW of the first measurement image 101A is easily measured.

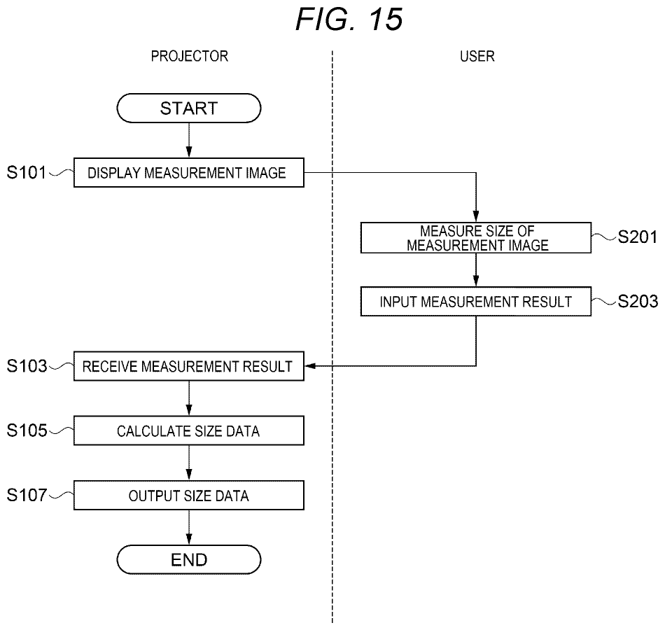

FIG. 15 shows a control flow executed by the projector 10 and the user. The control flow executed by the projector 10 corresponds to an example of a method for controlling the projector 10. The control flow executed by the projector 10 is executed by the controller 60 causing the control program CP to operate.

The projector 10 displays the measurement image 101 in step S101. The measurement image 101 is included in the OSD image 100. The OSD image 100 is projected in the projection image PG. For example, the projector 10 projects the first measurement image 101A as the measurement image 101. The first measurement image 101A is an image of the measured image width MW having a predetermined width ratio with respect to the image width PW of the projection image PG. The width ratio is an example of the ratio data, and is predetermined and known.

After the projector 10 displays the measurement image 101, the user measures a size of the measurement image 101 in step S201. The size of the measurement image 101 is any one of the measured image width MW, the measured image height MH, and the measured image length ML. When the projector 10 projects the first measurement image 101A as the measurement image 101, the user measures the measured image width MW of the measurement image 101.

After the size of the measurement image 101 is measured, the user inputs a measurement result to the projector 10 in step S203. The user inputs the measurement result of the size of the measurement image 101 as a measured value. The user inputs the measurement result to the projector 10 by using the operation panel 11 or the remote controller 700. For example, when the projector 10 projects the first measurement image 101A, the user inputs the measurement result of the measured image width MW as the measured value.

When the user inputs the measurement result to the projector 10, the projector 10 receives the measurement result in step S103. The operation panel 11 or the receiver 90 receives the measured value as the measurement result. When the user inputs the measured value by using the remote controller 700, the receiver 90 receives the measured value as an operation signal.

The projector 10 calculates the size data in step S105 after receiving the measured value. The data processor 63 of the projector 10 acquires the measured value. The data processor 63 calculates the size data of the projection image PG projected onto the projection surface SC based on the measured value and the ratio data. The ratio data is stored in the memory 70 in advance. When the measured value is the measured image width MW, the data processor 63 calculates the size data based on the measured value and the width ratio. The calculated size data is, for example, the diagonal line length Y.

After calculating the size data, the projector 10 outputs the size data in step S107. For example, the data processor 63 outputs the size data to the OSD controller 61. The OSD controller 61 acquires the size data. The OSD controller 61 causes the output value 110 indicating the size data to be projected in the OSD image 100. The output value 110 is projected in the projection image PG. The projector 10 projects the output value 110 onto the projection surface SC. The OSD controller 61 may adjust a size of an image displayed in the OSD image 100 other than the measurement image 101 based on the size data.

The data processor 63 may transmit the size data to the external device such as the image-providing device 500 via the communication interface 80. The image-providing device 500 acquires the size data. The image-providing device 500 corrects the image data based on the size data. The image-providing device 500 adjusts a size of a partial image included in the projection image PG projected onto the projection surface SC by correcting the image data.

The projector 10 includes the image-projecting device 30 and the controller 60. The controller 60 executes: projecting the image light of the projection image PG having the image size and including the measurement image 101 whose ratio data with respect to the image size is known onto the projection surface SC by using the image-projecting device 30; receiving an input of the input value 106 that is the length of the measurement image 101 on the projection surface SC; and outputting the size data that is the length of the projection image PG on the projection surface SC based on the input value 106 and the ratio data.

The projector 10 can calculate the image size of the projection image PG projected onto the projection surface SC by receiving the input of the input value 106 input by the user. The projector 10 does not need to include a distance-measuring sensor to calculate the image size of the projection image PG. An increase in a manufacturing cost of the projector 10 is prevented.

The method for controlling the projector 10 includes: projecting the image light of the projection image PG having the image size and including the measurement image 101 whose ratio data with respect to the image size is known onto the projection surface SC from the projector 10; receiving an input of the input value 106 that is the length of the measurement image 101 on the projection surface SC; and outputting the size data that is the length of the projection image PG on the projection surface SC based on the input value 106 and the ratio data.

The projector 10 can output the size data without using the distance-measuring sensor. The projector 10 does not need to include the distance-measuring sensor for calculating the size data. The manufacturing cost of the projector 10 is reduced.

The control program CP causes the projector 10 to execute: projecting the image light of the projection image PG having the image size and including the measurement image 101 whose ratio data with respect to the image size is known onto the projection surface SC from the projector 10; receiving an input of the input value 106 that is the length of the measurement image 101 on the projection surface SC; and outputting the size data that is the length of the projection image PG on the projection surface SC based on the input value 106 and the ratio data.

According to the control program CP, it is possible to provide the projector 10 that can output the size data without increasing the manufacturing cost of the projector 10.

A summary of the present disclosure will be described below.

### Appendix 1

A projector of the present disclosure includes: an optical device; and a processing device, and the processing device executes projecting image light of a projection image having a first length and including a first image whose length relationship with the first length is known onto a projection surface by using the optical device, receiving an input of a second length that is a length of the first image on the projection surface, and outputting information indicating a third length that is a length of the projection image on the projection surface based on the second length and the length relationship.

The projector can calculate the length of the projection image projected onto the projection surface by receiving the input of the second length input by a user. The projector does not need to include a distance-measuring sensor to calculate the image length of the projection image. An increase in a manufacturing cost of the projector is prevented.

### Appendix 2

In the projector according to Appendix 1, the projection image further includes a user interface image that receives the input of the second length, and receiving the input of the second length is receiving the input of the second length via the user interface image.

The user can easily understand that the second length is input to the user interface image displayed in the projection image.

### Appendix 3

In the projector according to Appendix 1 or 2, when the projection image is horizontally divided into two equal parts, the first image is disposed in a lower region.

The first image is disposed at a lower side when the projection image is horizontally divided into two equal parts, whereby the user easily accesses the first image. The user easily measures the length of the first image.

### Appendix 4

The projector according to any one of Appendixes 1 to 3 further includes an input device configured to receive a change operation of changing a projection position of the first image, in which the processing device changes the projection position of the first image based on the change operation.

The user can change the projection position of the measurement image to a position where the first image is easily measured.

### Appendix 5

In the projector according to any one of Appendixes 1 to 4, outputting the information indicating the third length includes projecting a second image representing the information indicating the third length onto the projection surface by using the optical device.

The user can confirm a size of the projection image projected onto the projection surface.

### Appendix 6

A method for controlling a projector of the present disclosure includes: projecting image light of a projection image having a first length and including a first image whose length relationship with the first length is known onto a projection surface from a projector; receiving an input of a second length that is a length of the first image on the projection surface; and outputting information indicating a third length that is a length of the projection image on the projection surface based on the second length and the length relationship.

The projector can output the information indicating the third length without using the distance-measuring sensor. The projector does not need to include the distance-measuring sensor for calculating the information indicating the third length. The manufacturing cost of the projector is reduced.

### Appendix 7

A program of the present disclosure causes a projector to execute: projecting image light of a projection image having a first length and including a first image whose length relationship with the first length is known onto a projection surface from a projector; receiving an input of a second length that is a length of the first image on the projection surface; and outputting information indicating a third length that is a length of the projection image on the projection surface based on the second length and the length relationship.

According to the program, it is possible to provide a projector that can output the size data without increasing the manufacturing cost of the projector.

What is claimed is:

1. A projector comprising: an optical device; and
a processing device, wherein
the processing device executes projecting image light of a projection image having a first length and including a first image whose length relationship with the first length is known onto a projection surface by using the optical device,
receiving an input of a second length that is a length of the first image on the projection surface, and
outputting information indicating a third length that is a length of the projection image on the projection surface based on the second length and the length relationship.

2. The projector according to claim 1, wherein
the projection image further includes a user interface image that receives the input of the second length, and
receiving the input of the second length is receiving the input of the second length via the user interface image.

3. The projector according to claim 1, wherein
when the projection image is horizontally divided into two equal parts, the first image is disposed in a lower region.

4. The projector according to claim 1, further comprising:
an input device configured to receive a change operation of changing a projection position of the first image, wherein
the processing device changes the projection position of the first image based on the change operation.

5. The projector according to claim 1, wherein
outputting the information indicating the third length includes projecting a second image representing the information indicating the third length onto the projection surface by using the optical device.

6. A method for controlling a projector, the method comprising:
projecting image light of a projection image having a first length and including a first image whose length relationship with the first length is known onto a projection surface from a projector;
receiving an input of a second length that is a length of the first image on the projection surface, and
outputting information indicating a third length that is a length of the projection image on the projection surface based on the second length and the length relationship.

7. A non-transitory computer-readable storage medium storing a program, the program causing a projector to execute:
projecting image light of a projection image having a first length and including a first image whose length relationship with the first length is known onto a projection surface;
receiving an input of a second length that is a length of the first image on the projection surface; and
outputting information indicating a third length that is a length of the projection image on the projection surface based on the second length and the length relationship.
